(19) United States
(12) Patent Application Publication
(10) Pub. No.: US 2026/0187371 A1
(43) Pub. Date: Jul. 2, 2026

(54) METHOD AND SYSTEM FOR IMPROVING RETRIEVAL ACCURACY IN RETRIEVAL AUGMENTED GENERATION (RAG) FRAMEWORK

(71) Applicant: LTI Mindtree Ltd, Mumbai (IN)

(72) Inventors: Anindita Desarkar, Mumbai (IN); Aritra Sen, Mumbai (IN); Vishwanathan Raman, Mumbai (IN)

(21) Appl. No.: 19/062,060

(22) Filed: Feb. 25, 2025

(30) Foreign Application Priority Data
Dec. 30, 2024 (IN) 202421104414

(51) Int. Cl. G06F 40/284; G06F 40/205; G06F 40/30

(52) U.S. Cl. CPC G06F 40/284; G06F 40/205; G06F 40/30

(57) ABSTRACT

Methods and systems for improving retrieval accuracy in a Retrieval Augmented Generation (RAG) framework are disclosed. Input documents (102) are analyzed using a Small Language Model (SLM) to identify document types and extract content using type-specific methods. An adaptive chunking process generates chunked content based on variables including use case type, speed, cost, latency requirements, and Large Language Model (LLM) context window size. The chunked content undergoes tokenization using strategies based on accuracy and vocabulary requirements. An embedding model is selected based on user requirements, and quantization policies are applied to generate optimized vector representations. Document portions are retrieved using a multi-step strategy comprising hybrid search, meta filters, multi-query retrieval, and hypothetical document embeddings. Performance is evaluated through context relevance, groundedness, and answer relevance scores, implementing parameter adjustments and re-evaluation processes when scores fall below thresholds.

### FIELD

Various embodiments of the present disclosure relate to Retrieval Augmented Generation (RAG). More particularly, the disclosure relates to an autonomous method and system for improving retrieval accuracy in a RAG framework.

### BACKGROUND

In recent years, Large Language Models (LLMs) have emerged as transformative tools in natural language processing, demonstrating remarkable capabilities in generating human-like text, answering complex queries, and performing various language-related tasks. However, LLMs are inherently limited by the scope of their training data, which is typically static and cannot incorporate proprietary, real-time, or domain-specific knowledge. To address this limitation, RAG has gained prominence as a strategy to enhance LLMs by integrating external knowledge into their operations. The approach significantly broadens the applicability of LLMs, making them suitable for enterprise-level use cases where specialized or proprietary information is essential.

However, achieving optimal results with RAG requires careful selection and implementation of appropriate techniques and parameters at various stages of the architecture. From selecting the retrieval mechanism, such as vector similarity searches or semantic embeddings, to designing prompt templates that effectively guide the generation process, each component in the RAG pipeline plays a critical role. If these elements are not correctly configured, the system may retrieve irrelevant information or fail to contextualize the data, leading to suboptimal application outcomes.

Predominantly, existing RAG-based systems encounter significant challenges during the chunking and embedding stages, which are critical for integrating external knowledge into the retrieval process. Chunking involves dividing large documents into smaller, manageable pieces that can be efficiently processed and indexed. However, this process is often time-intensive, as it requires careful consideration to balance granularity and context retention. Non-optimal chunk sizes can lead to either excessive overlap, causing redundancy, or insufficient detail, resulting in incomplete retrieval of relevant information. Both scenarios adversely impact the system's ability to provide accurate and contextually relevant responses.

The embedding process, which converts text chunks into vector representations for retrieval, adds another layer of complexity. Selecting an appropriate embedding model is often challenging due to the wide variety of models available, each with different strengths and limitations. Enterprises frequently struggle to identify models that align with their specific data characteristics and domain requirements. Furthermore, mismatches between the chunking strategy and the embedding model can exacerbate inefficiencies, leading to poor retrieval accuracy and increased latency.

Furthermore, existing RAG systems face substantial challenges in their retrieval mechanisms, which can significantly affect the quality of information provided to the LLM. The retrieval stage involves identifying the most relevant chunks of information from the external knowledge base in response to a query. However, ambiguities in how queries are formulated and interpreted often lead to mismatches between the intent of the query and the granularity of the retrieved content. For instance, a high-level query might retrieve overly detailed information, overwhelming the user or the model, while a highly specific query might result in overly generalized content, failing to address the user's needs.

The mismatches are further compounded by the lack of standardization in retrieval techniques. Existing RAG based systems often struggle to dynamically adjust the level of granularity in the retrieved content to align with the context and requirements of the query. This misalignment not only reduces the relevance of the output but also increases the computational overhead, as irrelevant or redundant data is processed unnecessarily.

Furthermore, existing RAG systems also encounter significant challenges in the augmentation phase, which directly impacts the quality and relevance of the generated output. Augmentation involves integrating retrieved content into the LLM's generative process to provide responses enriched with external knowledge. However, these systems often use incorrect or irrelevant context during this process, leading to outputs that are either misaligned with the user's query or contain inaccurate information.

One primary issue lies in the ranking of retrieved content. Current RAG systems frequently rely on suboptimal ranking algorithms that fail to prioritize the most relevant or contextually appropriate pieces of information. As a result, less pertinent data might be selected for augmentation, overshadowing the content that aligns more closely with the query's intent. This misstep introduces noise into the augmentation process, diluting the quality and focus of the generated output.

Furthermore, RAG systems also encounter challenges related to logical coherence and depth in their outputs, which can significantly undermine their utility and reliability. One persistent issue is the presence of contradictions or illogical statements, either embedded within the retrieved context or stemming from ambiguities in the user's question. This inconsistency not only affects the credibility of the generated content but can also mislead users, particularly in critical applications requiring high accuracy.

Another challenge is excessive verbosity in the generated content. RAG systems often produce overly lengthy responses, diluting the focus of the information and making it harder for users to extract actionable insights. The verbosity is compounded by a tendency to overlay generalized information rather than delivering precise, context-specific answers. Such outputs fail to address the specific needs of users, especially in enterprise or domain-specific scenarios.

The lack of depth in the generated content further exacerbates the problem. Instead of offering comprehensive and detailed insights, RAG systems frequently produce superficial responses that skim over key aspects of the query. This limitation hinders their applicability in scenarios that demand nuanced and in-depth analysis, such as technical documentation or legal research.

In addition, existing RAG-based systems face notable challenges in evaluating the quality of their generated responses, often resulting in outputs that lack meaningfulness and consistency. A critical shortcoming lies in their inability to establish reliable metrics or benchmarks for assessing response quality. The limitation hampers the ability of such systems to guarantee that the outputs align with user expectations, particularly in high-stakes applications where precision and relevance are paramount.

Furthermore, these systems often lack transparency in their evaluation processes. Users are frequently left without insights into how the system assesses or ranks the generated responses, leading to a trust deficit. The absence of clear criteria for determining quality or the rationale behind selecting specific content during augmentation makes it difficult for users to identify areas of improvement or refine the input queries for better results.

Therefore, considering the aforementioned challenges, there is a need for a solution that can improve systematically improve retrieval accuracy of RAG based systems, and improve response quality evaluation metrics along with use case-based latency and retrieval optimization.

### SUMMARY

Disclosed are various implementations of methods and systems for improving retrieval accuracy in a Retrieval Augmented Generation (RAG) framework.

In one implementation, a computer-implemented method includes analyzing input documents using a Small Language Model (SLM) to identify document types, extracting content using type-specific methods, implementing adaptive chunking based on variables including use case type and requirements, tokenizing the chunked content, selecting an embedding model, applying quantization policy, generating optimized vector representations, and retrieving relevant document portions using a multi-step strategy considering context relevance and groundedness.

In another implementation, a system includes a processor and memory storing instructions to perform similar document processing steps including document type identification, content extraction, adaptive chunking, tokenization, embedding model selection, quantization, vector optimization, and multi-step retrieval.

A further implementation provides a computer-implemented method for evaluating and optimizing a RAG system by calculating performance scores including context relevance, groundedness, and answer relevance between queries, retrieved documents, and generated responses. When scores fall below thresholds, the method initiates optimization by adjusting parameters and performs re-evaluation with subsequent improvements for Large Language Models (LLM) and Small Language Models (SLM).

Another implementation describes a system for RAG evaluation and optimization that includes a processor and memory configured to receive queries and responses, calculate performance scores, initiate optimization phases, and perform response re-evaluation with LLM and SLM improvements.

Yet another implementation provides a computer-implemented method for agent-based RAG orchestration using a build agent for system configuration and a query agent for query processing. The build agent configures the system by processing documents, selecting chunking processes, determining embedding models, configuring quantization policies, and establishing retrieval strategies. The query agent executes queries and retrieves documents while the build agent monitors performance.

A further implementation describes a system for agent-based RAG orchestration including a processor and memory that initialize build and query agents to manage system configuration and query processing respectively, with similar functionality for document processing, query execution, and performance monitoring.

These implementations provide comprehensive solutions for improving performance of RAG based application development framework through systematic document processing, performance evaluation, and agent-based orchestration.

One or more advantages of the prior art are overcome, and additional advantages are provided through the disclosure. In addition to illustrative aspects, embodiments, and features described above, further aspects, embodiments, and features will become apparent by reference to drawings and following detailed description.

### BRIEF DESCRIPTION OF THE FIGURES

FIG. 1 is a diagram that illustrates an exemplary environment within which various embodiments of the present disclosure may function.

FIG. 2 is a diagram that illustrates a block diagram of a system for improving the LLM response accuracy in a RAG framework, in accordance with an embodiment of the disclosure.

FIG. 3 is a diagram that illustrates a flow chart for a method for improving the LLM response accuracy in a RAG framework, in accordance with an embodiment of the disclosure.

FIG. 4 is a diagram that illustrates the system for evaluating and optimizing the RAG framework, in accordance with an embodiment of the disclosure.

FIG. 5 is a diagram that illustrates a flow chart for a method for evaluating and optimizing a RAG framework, in accordance with an embodiment of the disclosure.

FIG. 6 is a diagram that illustrates the system for agent-based orchestration of the RAG framework, in accordance with an embodiment of the disclosure.

FIG. 7 is a diagram that illustrates a flow chart for a method for agent-based orchestration of the RAG framework, in accordance with an embodiment of the disclosure.

### DETAILED DESCRIPTION

Pursuant to various embodiments of the present disclosure, the method and system enables improving retrieval accuracy in RAG framework. Each input document of a plurality of input documents are analyzed using a small language model (SLM) to identify a document type. The document type can be one of a markdown document, a programming code document, a tabular document, and an image-containing document. Content from each input document is extracted using document type-specific extraction model. Chunked content for the extracted document is generated by implementing an adaptive chunking process that is selected based on chunking variables such as a use case type, a speed requirement, a cost requirement, a latency requirement, and a large language model (LLM) context window size. The chunked content is tokenized using a tokenization strategy to generated tokenized content.

An embedding model for the tokenized content is selected based on user requirements, and a quantization policy is applied to the tokenized content to generate quantized vector representations. Optimized vector representations of the quantized vector representations are generated using the selected embedding model and the applied quantization policy. Relevant portions of the document content are then retrieved in response to a received query using a multi-step retrieval strategy, which considers both context relevance and groundedness.

Performance scores of generated responses are calculated based on, context relevance score between the query and the retrieved document portions, groundedness score between the generated response and the retrieved document portions, and answer relevance score between the query and the generated response.

An optimization phase is initiated by adjusting parameters of adaptive chunking process, an embedding model selection, a multi-step retrieval strategy comprising hybrid search, meta filters, multi-query retriever approach and hypothetical document embeddings, when at least one of the calculated performance score falls below a threshold. A response re-evaluation process is then performed to understand the improvement, and initiate a subsequent round of improvement for LLM and SLM if the re-evaluation response is determined to be unsatisfactory.

In one or more embodiments, chunked content refers to segments of information derived from input documents, which are divided into manageable and logically coherent portions to facilitate efficient processing within a RAG system. The chunking process involves splitting large documents or datasets into smaller sections, so that each segment contains sufficient context to be meaningful when retrieved independently.

In one or more embodiments, the SLM refers to a compact and efficient machine learning (ML) model designed to perform natural language processing (NLP) tasks, such as text classification, entity recognition, and semantic analysis, with lower computational resources compared to larger models. The SLM is trained on a narrower scope of language data and optimized for tasks that require faster processing and reduced memory usage.

In one or more embodiments, the embedding model refers to an ML model that transforms text or document data into numerical vectors or embeddings, which capture the semantic meaning of the content. The vectors represent the input data in a continuous vector space, enabling the system to compare, retrieve, or analyze text based on its meaning rather than just its surface-level features. The embedding model processes the text data and generates embeddings that can be used for downstream tasks such as information retrieval, clustering, or similarity matching.

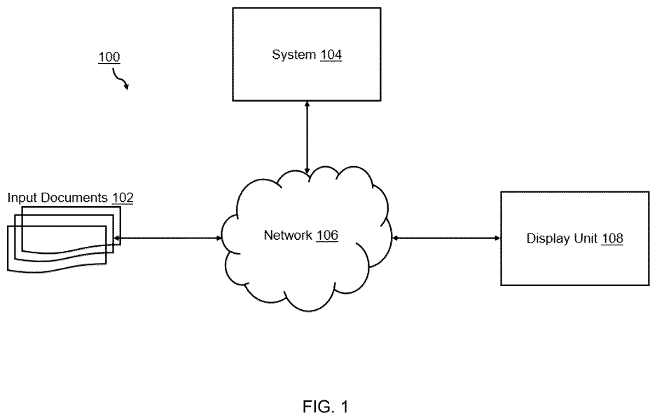

FIG. 1 is a diagram that illustrates an exemplary environment 100 within which various embodiments of the present disclosure may function. Referring to FIG. 1, the environment 100 comprises a plurality of input documents 102, a system 104, a network 106, and a display unit 108.

The plurality of input documents 102 refer to a wide variety of textual and non-textual information sources that serve as the foundational knowledge base for a RAG system. For instance, the plurality of input documents 102 may include, but are not limited to, technical manuals, research papers, legal documents, user guides, knowledge base articles, proprietary organizational data, structured datasets, reports, and customer support records.

In one or more embodiments, the plurality of input documents 102 may be received via a user interface (UI) that may be configured accordingly. The UI can be of one or more types such as, a graphical user interface (GUI), a command-line interface (CLI), or an application programming interface (API). The GUI may allow users to upload documents through drag-and-drop functionality or by selecting files from a directory, while the CLI may enable document submission via command-based inputs. The API can facilitate programmatic submission of documents from external systems or applications.

The system 104 is an end-to-end architecture that holistically enhances and improves retrieval accuracy of the RAG based applications in a systematic manner with minimal user intervention. The system 104 enables selection of appropriate techniques, methods, and processes in each level based on the user requirements.

In one or more embodiments, the system 104, in order to improve retrieval accuracy of the RAG framework, implements strategies at various levels such as, optimal chunking detection, appropriate tokenization, optimal embedding model selection, quantization strategy, advanced retrieval techniques, and custom packages for evaluation of RAG responses.

The network 106 includes communication networks operable to facilitate communication, either wirelessly or wired. The network 106 connects a plurality of computer systems. The network 106 may comprise, for example, an intranet, local area network, wide area network, the internet, public switched telephone network (PSTN), network of networks, or other network.

In one or more embodiments, the network 106 facilitates connection between the system 104 and the display unit 108 via one or more communication channels.

In one or more embodiments, the display unit 108 is configured to present the output to a user for evaluation of performance of the RAG framework. The display unit 108 can include, but is not limited to, devices such as, interactive dashboards, touchscreen displays, projection systems, and wearable displays.

In some non-limiting embodiments, the display unit 108 can be located within an enterprise environment or at any other remote location, providing flexibility in accessing and presenting insights to users. For instance, in an enterprise setting, the display unit 108 could be integrated into centralized workstations or conference room systems, facilitating collaborative decision-making among teams. Conversely, in remote locations, the display unit 108 could be accessed via portable devices such as laptops, tablets, or smartphones, for seamless connectivity and uninterrupted workflow regardless of the user's physical location.

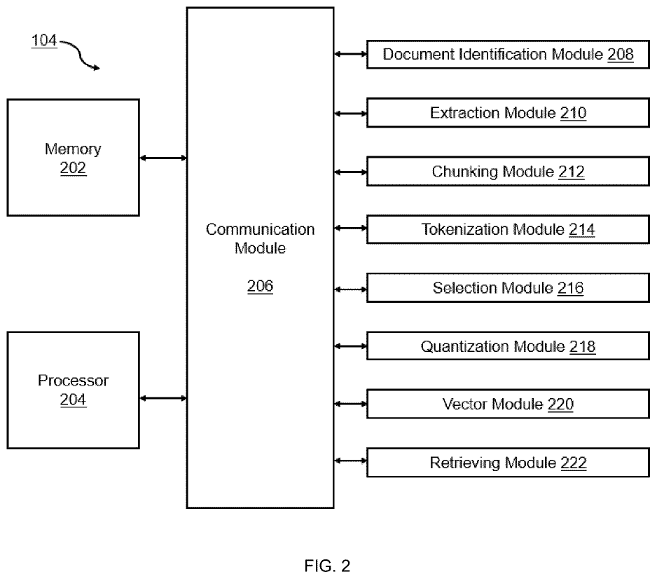

FIG. 2 is a diagram that illustrates a block diagram of the system 104 for improving the LLM response accuracy in a RAG framework, in accordance with an embodiment of the disclosure. Referring to FIG. 2, the system 104 comprises a memory 202, a processor 204, a communication module 206, a document identification module 208, an extraction module 210, a chunking module 212, a tokenization module 214, a selection module 216, a quantization module 218, a vector module 220, and a retrieval module 222.

The memory 202 may comprise suitable logic, and/or interfaces, that may be configured to store instructions (for example, computer-readable program code) that can implement various aspects of the present disclosure.

The processor 204 may comprise suitable logic, interfaces, and/or code that may be configured to execute the instructions stored in the memory 202 to implement various functionalities of the system 104 in accordance with various aspects of the present disclosure. The processor 204 may be further configured to communicate with the various modules of the system 104 through the communication module 206, which manages internal and external data communications.

The system 104, upon receiving the plurality of input documents 102 via the UI, may process each document through a series of preprocessing steps designed to standardize and optimize the content. The preprocessing techniques are employed to handle various document formats so that they can be effectively processed and analyzed. The system 104 converts all incoming documents, regardless of their original format, into a single, unified format for consistency across the entire dataset.

In an exemplary embodiment, the various formats that the system 104 can handle during preprocessing include, but are not limited to, common document types such as .pdf, .docx, .doc, .odt, .pptx, .ppt, .xlsx, .csv, .tsv, .eml, .msg, .rtf, .epub, .html, .xml, as well as image formats like .png and .jpg, and text formats like .txt. The system 104 is designed to recognize and convert these diverse formats into a unified format that facilitates seamless processing and analysis.

The document identification module 208 may comprise suitable logic, code, and interfaces that may be configured to analyze each of the plurality of input documents 102 using the SLM to identify a document type. The document identification module 208 operates by processing the textual content of each document and applying the SLM to recognize patterns, structures, and content characteristics that define the type of document.

In some non-limiting embodiments, the SLM used for analyzing each of the plurality of documents is DistilBERT, a lightweight, optimized version of BERT (Bidirectional Encoder Representations from Transformers) that retains much of the power and accuracy of the BERT model while being more efficient in terms of speed and resource usage. However, alternatively, other SLMs may be used for analyzing the documents, depending on the specific requirements and constraints of the system 104. The alternative models could include other transformer-based models, or even more specialized models trained for specific document types or domains.

In one or more embodiments, the identified document type can include, but is not limited to, a markdown document, a programming code document, a tabular document, and an image-containing document.

The extraction module 210 may comprise suitable logic, code, and/or interfaces that may be configured to extract document content from each input document using document type-specific extraction methods.

In an exemplary embodiment, for markdown document, the extraction module 210 may use pattern recognition to identify and extract text content, headers, lists, and links, bypassing formatting elements like bold or italic text that are not relevant for information retrieval. Markdown-specific parsers may be employed to preserve structure and facilitate easy conversion to plain text or other formats.

In an exemplary embodiment, for programming code documents, the extraction module 210 may extract programming code using specialized syntax parsers designed to handle various programming languages. The extraction module 210 may identify and retrieve code blocks, comments, functions, and variables, to retain syntactic structure of the extracted for later analysis or processing.

In an exemplary embodiment, for tabular documents, the extraction module 210 leverages table parsers to detect rows, columns, headers, and cell content. The method allows for structured data extraction from spreadsheets, CSV files, and other tabular formats, preserving the relationships between data points in a format that can be used for further processing. For instance, if the table includes sales data, the extraction module 210 generates a summary like, “The table includes sales figures for Q1 to Q4, with the highest sales recorded in Q3, showing a 20% increase compared to the previous quarter.”

In an exemplary embodiment, when the document contains images, the extraction module 210 may use optical character recognition (OCR) technologies or image analysis tools to extract embedded text from the images. The content extraction process focuses on detecting text within image files and extracting relevant textual data, while also accounting for image metadata, if applicable. For example, if an image contains a bar chart, the extraction module 210 could summarize the data as, “The bar chart represents the growth in revenue over five years, with a steady increase each year, reaching a peak of $5M in 2023.”

In one or more embodiments, the extraction module 210 is further configured to convert the extracted table and image content within the document to text summaries, to represent relevant information from tables and images in a human-readable format, facilitating analysis and retrieval.

The chunking module 212 may comprise suitable logic, code, and/or interfaces that may be configured to generate chunked content by implementing an adaptive chunking process for the extracted document content.

In one or more embodiments, the adaptive chunking process refers to a dynamic method of dividing extracted content from input documents into smaller, contextually meaningful segments (or “chunks”) based on the structure, type, and content of the document. The process adapts to different content types (e.g., textual, tabular, or image-based) and adjusts the chunk sizes accordingly to optimize processing efficiency and accuracy in subsequent stages of the system. The adaptive chunking process employs algorithms that analyze the content and determines appropriate boundaries for creating chunks.

In one or more embodiments, the adaptive chunking process is selected based on chunking variables comprising, a user case type, a speed requirement, a cost requirement, a latency requirement, and a LLM context window size. The chunking variables collectively influence the granularity and method by which content is chunked to align the chunking process with the specific needs of the user.

In an exemplary embodiment, the chunking process is tailored to the specific use case at hand. For instance, if the use case involves generating summaries, chunks may be smaller to preserve detailed context. If the use case involves high-level topic extraction, chunks may be larger to group related content.

In an exemplary embodiment, if there is a need for speed processing, the chunking process may prioritize fewer, larger chunks to reduce the time spent in segmentation. Alternatively, for applications that demand more granular analysis, the chunking process may generate smaller chunks that can be processed quickly.

In an exemplary embodiment, in environments where cost efficiency is a priority, the chunking process may be adjusted to balance processing time with computational cost. Larger chunks may be preferred to optimize for fewer API calls or interactions with external services, while smaller chunks might be used if finer granularity is needed but without significant cost increases.

In an exemplary embodiment, for applications with strict latency constraints, the chunking process may prioritize the creation of smaller chunks that can be processed faster, thus reducing overall response time. In contrast, applications with less stringent latency requirements may employ larger chunks to reduce overhead caused by chunk management.

In an exemplary embodiment, if the LLM has a limited context window, the chunking process will create smaller, more focused chunks to fit within that window so as to process each chunk effectively by the LLM, preserving the contextual relevance of the input without exceeding the model's capacity for token processing.

In one or more embodiments, the chunking module 212 determines one or more recommended chunking strategies from fixed-length chunking, sliding window chunking, semantic chunking, and agent-based chunking based on the chunking variables. Thereafter, the chunking module 212 implements at least one of the determined chunking strategies to generate the chunked content.

In one or more embodiments, the fixed-length chunking divides the document content into chunks of a predefined length. It is typically used when uniformity in chunk size is necessary, or when the processing speed is a primary concern.

In one or more embodiments, sliding window chunking divides the content into overlapping chunks, where each chunk shares some portion of its content with the adjacent chunks.

In one or more embodiments, for semantic chunking, the chunking module 212 groups content based on semantic meaning, such as sentence boundaries or topic shifts. By implementing semantic chunking, the chunking module 212 ensures that each chunk represents a coherent unit of meaning, which is especially useful for content that requires deeper understanding.

In one or more embodiments, in agent-based chunking, an agent or set of agents may be responsible for dividing content into chunks based on dynamic criteria, such as user preferences or document structure. The agent-based chunking adapts more fluidly to varying types of documents and is particularly useful for scenarios where different sections of the document might require different chunking strategies depending on the content's role or importance.

In one or more embodiments, the chunking module 212 implements the determined chunking strategy by initially monitoring chunk effectiveness metrics, which include context relevance and chunk utilization, for the chunked content. Context relevance refers to how well the content within each chunk maintains its semantic integrity. Chunk utilization measures how efficiently the chunks are being used to enable appropriate distribution of the content across the chunks without significant waste of space or important information.

In one or more embodiments, the chunking module 212 dynamically adjusts the chunk size and overlap size based on the monitored chunk effectiveness metrics. For example, if the context relevance falls below an acceptable level, the chunk size may be adjusted to include more content for a richer context. Similarly, if chunk utilization is low, the module may modify the overlap size for more efficient usage of the chunked content.

In one or more embodiments, if after these adjustments, the monitored chunk effectiveness metrics fall below predefined thresholds indicating that the chunking process is still not performing optimally, the chunking module 212 further optimizes the adjusted chunk size and overlap size using a genetic algorithm, which operates by evaluating multiple potential chunk configurations, each representing a genetic solution to the chunking process. The genetic algorithm iteratively evolves the chunking strategy by selecting the best-performing configurations and combining them to generate improved solutions.

The tokenization module 214 may comprise suitable logic, code, and/or interfaces that may be configured to tokenize the chunked content using a tokenization strategy to generate tokenized content. Tokenization refers to the process of splitting the chunked content into smaller, manageable units, typically called tokens, which can be words, phrases, or symbols.

In one or more embodiments, the tokenization module 214 selects the tokenization strategy based on tokenization variables comprising the use case type, an accuracy requirement, a speed requirement, and a vocabulary type.

In one or more embodiments, if the use case involves text generation, sub word-level tokenization might be preferred to capture more nuanced semantic meanings. Alternatively, for tasks requiring quick responses, word-level tokenization may be more efficient.

In one or more embodiments, if the application demands high accuracy in understanding and processing the content, a more granular tokenization approach, such as sub word-level tokenization or character-level tokenization, might be chosen to ensure that no crucial information is lost during tokenization.

In one or more embodiments, for speed requirements, the tokenization strategy might lean towards more simplistic approaches, such as word-level tokenization or sentence-level tokenization, which can be processed more quickly, providing faster results.

In one or more embodiments, the vocabulary type refers to the linguistic characteristics of the document being processed. For instance, the system 104 processing a formal, structured document may benefit from a tokenization strategy that recognizes specific terminology or technical jargon. In contrast, a more general document (e.g., an article or blog post) might be handled effectively with a standard word-level tokenization strategy.

The selection module 216 may comprise suitable logic, code, and/or interfaces that may be configured to select an embedding model for the tokenized content based on user requirements.

In one or more embodiments, the embedding model is a machine learning model designed to convert text or document data into numerical vectors, known as embeddings, that encapsulate the semantic meaning of the content. The vectors map the input data into a continuous vector space, allowing the system to perform comparisons, retrievals, or analyses based on the underlying meaning of the text rather than its superficial attributes.

In one or more embodiments, the selection module 216 selects the embedding model by receiving the user requirements such as domain type, cost requirements, performance requirements, accuracy requirements, and model size constraints.

In one or more embodiments, upon receiving the user requirements, the selection module 216 compares the received user requirements against embedding model parameters such as, model architecture, resource usage, domain applicability, training data type, and model size, and then selects the embedding model having parameters that satisfy the received user requirements.

In one or more embodiments, the selection module 216 analyzes the model architecture, which defines the structure and design of the embedding model, including its layers, activation functions, and mechanisms for handling input data. The selection module 216 also considers resource usage, including the computational power and memory required by the embedding model. As the selection module 216 verifies if the embedding model has been trained on data or adapted for the specific domain indicated in the user requirements. The selection module 216 reviews the training data type, determining whether the selection model's training data encompasses the formats, vocabularies, and contexts relevant to the user's needs. Finally, the selection module 216 examines the model size, which impacts storage and deployment feasibility. Smaller models may be preferred for edge devices or cost-sensitive applications, while larger models may be necessary for more complex or high-accuracy tasks.

The quantization module 218 may comprise suitable logic, code, and/or interfaces that may be configured to generate quantized vector representations by applying a quantization policy to the tokenized content.

In one or more embodiments, applying a quantization policy reduces the numerical precision of the vectors while preserving their essential semantic information. Accordingly, the quantization module 218 may convert the high-dimensional tokenized data into a more compact and efficient representation, which can be processed and stored with reduced computational and memory overhead.

In one or more embodiments, the quantization module 218 selects the quantization policy based on an accuracy requirement, budget requirements, and a search latency requirement.

In one or more embodiments, applying the quantization policy by the quantization module 218 involves determining a target compression level for the vector representations based on the budget requirement, and generating compressed vector representations at the determined target compression level.

The target compression level determined by the quantization module 218 refers to the degree to which the vector representations are reduced in size or dimensionality while retaining essential semantic information. The target compression level may be determined based on factors such as computational and storage budget constraints, the desired accuracy of the downstream tasks, and the acceptable latency for retrieval or processing operations.

In one or more embodiments, the quantization module 218 upon generating compressed vector representations, compares retrieval accuracy and search latency of the compressed vector representations against uncompressed vector representations. Thereafter, the target compression level is modified when either the retrieval accuracy or search latency fails to meet predetermined thresholds.

The vector module 220 may comprise suitable logic, code, and/or interfaces that may be configured to generate optimized vector representations of the quantized vector representations using the selected embedding model and the applied quantization policy. The embedding model translates the tokenized content into a numerical format that captures the semantic meaning, while the quantization policy reduces the size of the vector representations for efficient storage and processing.

The retrieving module 222 may comprise suitable logic, code, and/or interfaces that may be configured to retrieve relevant portions of the document content, in response to a received query. Relevant portions of the document can be both contextually relevant and grounded in the information provided.

In one or more embodiments, the retrieving module 222 utilizes a multi-step retrieval strategy for retrieving relevant portions of the document content, which involves hybrid search, meta filters, multi-query retriever approach, and hypothetical document embeddings. The retrieving module 222 considers both context relevance and groundedness for the retrieval strategy.

In one or more embodiments, the retrieving module 222 converts the received query into a query vector using the selected embedding model and executes the multi-step retrieval strategy.

In some non-limiting embodiments, the query vector can be numerical representation of the received query that captures its semantic meaning, generated by applying the selected embedding model to the textual content of the query. The query vector is typically a high-dimensional vector, where each dimension represents a specific feature or relationship within the query, allowing for effective comparison with the document content vectors during the retrieval process.

In one or more embodiments, the retrieving module 222 executes the multi-step retrieval strategy by performing a semantic search using vector similarity between the query vector and the optimized vector representations, and thereby performing a keyword-based search of the document content.

In one or more embodiments, the retrieval module 222 implements the hybrid search by combining vector similarity scores from the semantic search with keyword match scores, and filtering the combined results using document metadata and content-type filters, and expanding the query using automatically generated variations.

In one or more embodiments, the retrieval module 222 applies meta filters to the combined results based on document metadata and executes the multi-query retriever approach by semantically similar query variations.

In one or more embodiments, the retrieval module 222 utilizes the hypothetical document embeddings by generating synthetic document representations for improved matching, and generating a comprehensive set of relevant document portions from the executed retrieval strategy.

In one or more embodiments, the retrieval module 222 finally ranks the comprehensive set based on the context relevance and groundedness.

In one or more embodiments, the system 104 is also configured to calculate a performance score based on one or more of a context relevance between the received query and retrieved document portions, a groundedness between a generated response and the retrieved document portions, and an answer relevance between the received query and the generated response.

In one or more embodiments, context relevance refers to how well the retrieved document portions align with the context of the received query. The system 104 evaluates the semantic similarity between the query and the retrieved content to ensure that the information retrieved is contextually appropriate and relevant to the user's request.

In one or more embodiments, the groundedness measures the degree to which the generated response is supported by the content of the retrieved document portions. It ensures that the system's 104 output is not only contextually relevant but also factually accurate, deriving its information directly from the retrieved sources rather than from unverified or externally generated content.

In one or more embodiments, the answer relevance assesses how well the generated response directly addresses the specifics of the received query. It evaluates the precision and pertinence of the answer in relation to the user's intent, to make the system's 104 response is directly applicable and meaningful to the question posed.

In one or more embodiments, upon determining that the performance score is below a threshold value, the system 104 adjusts parameters for one or more of the adaptive chunking process, the embedding model selection, the hybrid search, the meta filters, the multi-query retriever approach, and the hypothetical document embeddings.

In one or more embodiments, the system 104 may modify the chunking strategy, such as altering the chunk size or overlap, for more accurate context retrieval and better alignment with the query. Adjustments may involve refining the chunking approach, such as shifting from fixed-length chunking to more dynamic or semantic chunking, based on the specific characteristics of the content and the user's requirements.

In one or more embodiments, if the performance score indicates a mismatch between the retrieved content and the generated response, the system 104 may select a different embedding model with a more suitable architecture for the task, which makes representation of the content better in vector space, improving the retrieval process and the overall relevance of the generated responses.

In one or more embodiments, the system 104 may adjust the hybrid search mechanism by tweaking the balance between vector similarity scores and keyword-based search scores, which involves fine-tuning the weight of the results from semantic search versus traditional keyword matching, depending on the nature of the query and the content being retrieved.

In one or more embodiments, the system 104 may modify the meta filters applied to the retrieved content, such as adjusting the document metadata and content-type filters. The adjustments make sure that only the most relevant portions of the document content are selected, improving the quality of the response and the accuracy of the retrieval process.

In one or more embodiments, if the retrieval process is not yielding satisfactory results, the system 104 refines the multi-query retriever approach by generating new, semantically similar query variations. The variations may capture additional aspects of the query that were previously overlooked, for more comprehensive and relevant document retrieval.

In one or more embodiments, the system 104 may further adjust the use of hypothetical document embeddings by refining the synthetic document representations, which allows the system 104 to improve matching between the query and the retrieved content by generating more accurate or diverse hypothetical representations that better capture the query's context.

In one or more embodiments, the system 104 performs the re-evaluation of the response to understand the improvement. The re-evaluation may utilize metrics such as accuracy, relevance, context grounding, and precision to determine the degree of improvement in retrieval performance.

In one or more embodiments, after performing the response re-evaluation, the system 104 determines whether the generated response meets predefined satisfaction criteria. If the response is satisfactory, the system 104 finalizes the results for further processing or presentation to the user. However, if the response falls short of the required standards, the system 104 initiates another iteration of improvement, which may involve fine-tuning both the LLM and the SLM.

In one or more embodiments, for LLM, the system 104 proposes sentence window retrieval and auto merging retrieval, to get the better completion along with hyper-parameter tuning. Sentence window retrieval involves dynamically selecting and retrieving smaller, contextually relevant text segments from the chunked content based on the received query.

In one or more embodiments, auto-merging retrieval further refines the process by intelligently combining overlapping or related segments into cohesive units, where the context remains intact while eliminating redundancy. In addition to these strategies, the system 104 applies hyper-parameter tuning to optimize key parameters of the LLM, such as learning rates, batch sizes, attention mechanisms, and context window configurations.

In one or more embodiments, for SLM, the system 104 proposes poly-encoder-re-ranker. The poly-encoder re-ranker is a sophisticated neural ranking mechanism designed to improve the selection and prioritization of document content based on contextual relevance. The approach enables the SLM to efficiently evaluate and rank potential matches by leveraging multi-dimensional embeddings, which capture complex relationships between the input query and the extracted content.

In one or more embodiments, the poly-encoder re-ranker operates by comparing the query embeddings with precomputed document embeddings, utilizing an attention mechanism to identify the most contextually relevant portions of the content.

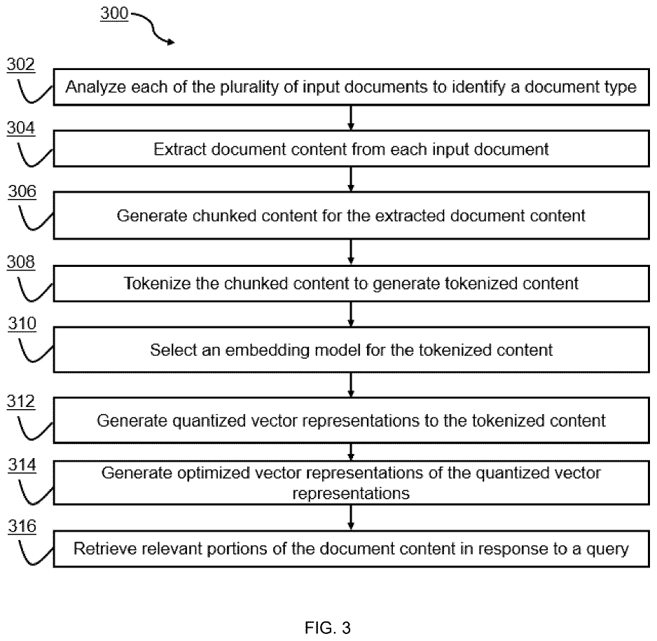

FIG. 3 is a diagram that illustrates a flow chart 300 for a method for improving the LLM response accuracy in a RAG framework, in accordance with an embodiment of the disclosure.

The system 104, upon receiving the plurality of input documents 102 via the UI, may process each document through a series of preprocessing steps designed to standardize and optimize the content. The preprocessing techniques are employed to handle various document formats so that they can be effectively processed and analyzed. The system 104 converts all incoming documents, regardless of their original format, into a single, unified format for consistency across the entire dataset.

At 302, each of the plurality of input documents 102 are analyzed by the document identification module 208 using the SLM to identify a document type. The document identification module 208 operates by processing the textual content of each document and applying the SLM to recognize patterns, structures, and content characteristics that define the type of document.

At 304, document content is extracted from each input document using document type-specific extraction methods by the extraction module 210.

In one or more embodiments, the extraction module 210 is further configured to convert the extracted table and image content within the document to text summaries, to represent relevant information from tables and images in a human-readable format, facilitating analysis and retrieval.

At 306, chunked content is generated by the chunking module 212 by implementing an adaptive chunking process for the extracted document content.

In one or more embodiments, the adaptive chunking process refers to a dynamic method of dividing extracted content from input documents 102 into smaller, contextually meaningful segments (or “chunks”) based on the structure, type, and content of the document. The process adapts to different content types (e.g., textual, tabular, or image-based) and adjusts the chunk sizes accordingly to optimize processing efficiency and accuracy in subsequent stages of the system. The adaptive chunking process employs algorithms that analyze the content and determines appropriate boundaries for creating chunks.

In one or more embodiments, the adaptive chunking process is selected based on chunking variables comprising, a user case type, a speed requirement, a cost requirement, a latency requirement, and a LLM context window size. The chunking variables collectively influence the granularity and method by which content is chunked to align the chunking process with the specific needs of the user.

In one or more embodiments, the chunking module 212 determines one or more recommended chunking strategies from fixed-length chunking, sliding window chunking, semantic chunking, and agent-based chunking based on the chunking variables. Thereafter, the chunking module 212 implements at least one of the determined chunking strategies to generate the chunked content.

In one or more embodiments, the fixed-length chunking divides the document content into chunks of a predefined length. It is typically used when uniformity in chunk size is necessary, or when the processing speed is a primary concern.

In one or more embodiments, sliding window chunking divides the content into overlapping chunks, where each chunk shares some portion of its content with the adjacent chunks.

In one or more embodiments, for semantic chunking, the chunking module 212 groups content based on semantic meaning, such as sentence boundaries or topic shifts. By implementing semantic chunking, the chunking module 212 ensures that each chunk represents a coherent unit of meaning, which is especially useful for content that requires deeper understanding.

At 308, the chunked content is tokenized by the tokenization module 214 using a tokenization strategy to generate tokenized content. Tokenization refers to the process of splitting the chunked content into smaller, manageable units, typically called tokens, which can be words, phrases, or symbols.

In one or more embodiments, the tokenization module 214 selects the tokenization strategy based on tokenization variables comprising the use case type, an accuracy requirement, a speed requirement, and a vocabulary type.

In one or more embodiments, if the use case involves text generation, sub word-level tokenization might be preferred to capture more nuanced semantic meanings. Alternatively, for tasks requiring quick responses, word-level tokenization may be more efficient.

In one or more embodiments, if the application demands high accuracy in understanding and processing the content, a more granular tokenization approach, such as sub word-level tokenization or character-level tokenization, might be chosen to make sure that no crucial information is lost during tokenization.

In one or more embodiments, for speed requirements, the tokenization strategy might lean towards more simplistic approaches, such as word-level tokenization or sentence-level tokenization, which can be processed more quickly, providing faster results.

In one or more embodiments, the vocabulary type refers to the linguistic characteristics of the document being processed. For instance, the system 104 processing a formal, structured document may benefit from a tokenization strategy that recognizes specific terminology or technical jargon. In contrast, a more general document (e.g., an article or blog post) might be handled effectively with a standard word-level tokenization strategy.

At 310, the selection module 216 selects an embedding model for the tokenized content based on user requirements.

In one or more embodiments, the embedding model is a machine learning model designed to convert text or document data into numerical vectors, known as embeddings, that encapsulate the semantic meaning of the content. The vectors map the input data into a continuous vector space, allowing the system to perform comparisons, retrievals, or analyses based on the underlying meaning of the text rather than its superficial attributes.

In one or more embodiments, the selection module 216 selects the embedding model by receiving the user requirements such as domain type, cost requirements, performance requirements, accuracy requirements, and model size constraints.

In one or more embodiments, upon receiving the user requirements, the selection module 216 compares the received user requirements against embedding model parameters such as, model architecture, resource usage, domain applicability, training data type, and model size, and then selects the embedding model having parameters that satisfy the received user requirements.

In one or more embodiments, the selection module 216 analyzes the model architecture, which defines the structure and design of the embedding model, including its layers, activation functions, and mechanisms for handling input data. The selection module 216 also considers resource usage, including the computational power and memory required by the embedding model. As the selection module 216 verifies if the embedding model has been trained on data or adapted for the specific domain indicated in the user requirements. The selection module 216 reviews the training data type, determining whether the selection model's training data encompasses the formats, vocabularies, and contexts relevant to the user's needs. Finally, the selection module 216 examines the model size, which impacts storage and deployment feasibility. Smaller models may be preferred for edge devices or cost-sensitive applications, while larger models may be necessary for more complex or high-accuracy tasks.

At 312, quantized vector representations are generated by applying a quantization policy to the tokenized content by the quantization module 218.

In one or more embodiments, applying a quantization policy reduces the numerical precision of the vectors while preserving their essential semantic information. Accordingly, the quantization module 218 may convert the high-dimensional tokenized data into a more compact and efficient representation, which can be processed and stored with reduced computational and memory overhead.

In one or more embodiments, the quantization module 218 selects the quantization policy based on an accuracy requirement, budget requirements, and a search latency requirement.

In one or more embodiments, applying the quantization policy by the quantization module 218 involves determining a target compression level for the vector representations based on the budget requirement, and generating compressed vector representations at the determined target compression level.

The target compression level determined by the quantization module 218 refers to the degree to which the vector representations are reduced in size or dimensionality while retaining essential semantic information. The target compression level may be determined based on factors such as computational and storage budget constraints, the desired accuracy of the downstream tasks, and the acceptable latency for retrieval or processing operations.

In one or more embodiments, the quantization module 218 upon generating compressed vector representations, compares retrieval accuracy and search latency of the compressed vector representations against uncompressed vector representations. Thereafter, the target compression level is modified when either the retrieval accuracy or search latency fails to meet predetermined thresholds.

At 314, optimized vector representations of the quantized vector representations are generated by the vector module 220 using the selected embedding model and the applied quantization policy. The embedding model translates the tokenized content into a numerical format that captures the semantic meaning, while the quantization policy reduces the size of the vector representations for efficient storage and processing.

At 316, the retrieving module 222 retrieves relevant portions of the document content, in response to a received query.

In one or more embodiments, the retrieving module 222 utilizes a multi-step retrieval strategy for retrieving relevant portions of the document content, which involves hybrid search, meta filters, multi-query retriever approach, and hypothetical document embeddings. The retrieving module 222 considers both context relevance and groundedness for the retrieval strategy.

In one or more embodiments, the retrieving module 222 converts the received query into a query vector using the selected embedding model and executes the multi-step retrieval strategy.

In one or more embodiments, the retrieving module 222 executes the multi-step retrieval strategy by performing a semantic search using vector similarity between the query vector and the optimized vector representations, and thereby performing a keyword-based search of the document content.

In one or more embodiments, the retrieval module 222 implements the hybrid search by combining vector similarity scores from the semantic search with keyword match scores, and filtering the combined results using document metadata and content-type filters, and expanding the query using automatically generated variations.

In one or more embodiments, the retrieval module 222 applies meta filters to the combined results based on document metadata and executes the multi-query retriever approach by semantically similar query variations.

In one or more embodiments, the retrieval module 222 utilizes the hypothetical document embeddings by generating synthetic document representations for improved matching, and generates a comprehensive set of relevant document portions from the executed retrieval strategy.

In one or more embodiments, the retrieval module 222 finally ranks the comprehensive set based on the context relevance and groundedness.

In one or more embodiments, the method 300 calculates a performance score based on at least one of a context relevance between the received query and retrieved document portions, a groundedness between a generated response and the retrieved document portions, and an answer relevance between the received query and the generated response.

In one or more embodiments, upon determining that the performance score is below a threshold value, the method 300 adjusts parameters for one or more of the adaptive chunking process, the embedding model selection, the hybrid search, the meta filters, the multi-query retriever approach, and the hypothetical document embeddings.

In one or more embodiments, the method 300 performs the re-evaluation of the response to understand the improvement. The re-evaluation may utilize metrics such as accuracy, relevance, context grounding, and precision to determine the degree of improvement in retrieval performance.

In one or more embodiments, after performing the response re-evaluation, the method 300 determines whether the generated response meets predefined satisfaction criteria. If the response is satisfactory, the method 300 finalizes the results for further processing or presentation to the user. However, if the response falls short of the required standards, the method 300 initiates another iteration of improvement, which may involve fine-tuning both the LLM and the SLM.

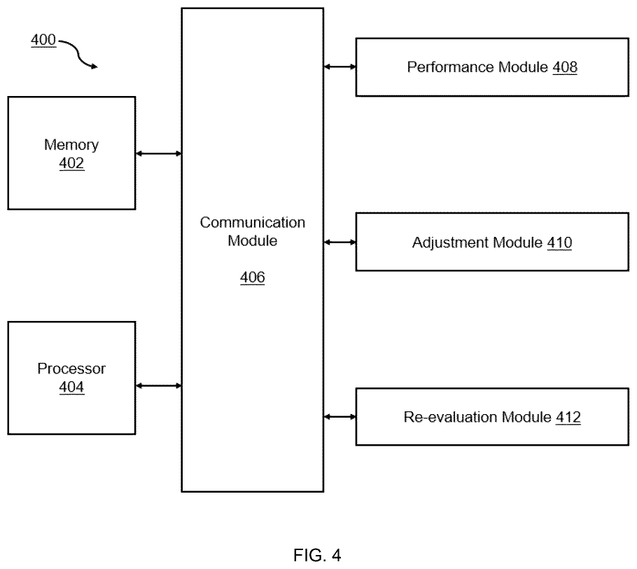

FIG. 4 is a diagram that illustrates a system 400 for evaluating and optimizing a RAG framework, in accordance with an embodiment of the disclosure. Referring to FIG. 4, the system 400 includes a memory 402, a processor 404, a communication module 406, a performance module 408, an adjustment module 410, and a re-evaluation module 412.

The memory 402 may comprise suitable logic, and/or interfaces, that may be configured to store instructions (for example, computer-readable program code) that can implement various aspects of the present disclosure.

The processor 404 may comprise suitable logic, interfaces, and/or code that may be configured to execute the instructions stored in the memory 402 to implement various functionalities of the system 400 in accordance with various aspects of the present disclosure. The processor 404 may be further configured to communicate with the various modules of the system 400 through the communication module 406, which manages internal and external data communications.

The performance module 408 may comprise suitable logic code, and/or interfaces that may be configured to calculate a performance score based on one or more of a context relevance between the received query and retrieved document portions, a groundedness between a generated response and the retrieved document portions, and an answer relevance between the received query and the generated response.

In one or more embodiments, context relevance refers to how well the retrieved document portions align with the context of the received query. The system 400 evaluates the semantic similarity between the query and the retrieved content to ensure that the information retrieved is contextually appropriate and relevant to the user's request.

In one or more embodiments, the groundedness measures the degree to which the generated response is supported by the content of the retrieved document portions. It ensures that the RAG framework's output is not only contextually relevant but also factually accurate, deriving its information directly from the retrieved sources rather than from unverified or externally generated content.

In one or more embodiments, the answer relevance assesses how well the generated response directly addresses the specifics of the received query. It evaluates the precision and pertinence of the answer in relation to the user's intent, to make the RAG framework's response directly applicable and meaningful to the question posed.

The adjustment module 410 may comprise suitable logic, code, and/or interfaces that may be configured to adjust parameters for one or more of the one or more of the adaptive chunking process, the embedding model selection, the hybrid search, the meta filters, the multi-query retriever approach, and the hypothetical document embeddings upon determining that the performance score is below a threshold value.

In one or more embodiments, the adjustment module 410 may modify the chunking strategy, such as altering the chunk size or overlap, for more accurate context retrieval and better alignment with the query. Adjustments may involve refining the chunking approach, such as shifting from fixed-length chunking to more dynamic or semantic chunking, based on the specific characteristics of the content and the user's requirements.

In one or more embodiments, if the performance score indicates a mismatch between the retrieved content and the generated response, the adjustment module 410 may select a different embedding model with a more suitable architecture for the task, which makes representation of the content better in vector space, improving the retrieval process and the overall relevance of the generated responses.

In one or more embodiments, the adjustment module 410 may adjust the hybrid search mechanism by tweaking the balance between vector similarity scores and keyword-based search scores, which involves fine-tuning the weight of the results from semantic search versus traditional keyword matching, depending on the nature of the query and the content being retrieved.

In one or more embodiments, the adjustment module 410 may modify the meta filters applied to the retrieved content, such as adjusting the document metadata and content-type filters. The adjustments make sure that only the most relevant portions of the document content are selected, improving the quality of the response and the accuracy of the retrieval process.

In one or more embodiments, if the retrieval process is not yielding satisfactory results, the adjustment module 410 refines the multi-query retriever approach by generating new, semantically similar query variations. The variations may capture additional aspects of the query that were previously overlooked, for more comprehensive and relevant document retrieval.

In one or more embodiments, the adjustment module 410 may further adjust the use of hypothetical document embeddings by refining the synthetic document representations, which allows the RAG Framework to improve matching between the query and the retrieved content by generating more accurate or diverse hypothetical representations that better capture the query's context.

The re-evaluation module 412 may comprise suitable logic, code, and/or interfaces that may be configured to perform re-evaluation of the response to understand the improvement. The re-evaluation may utilize metrics such as accuracy, relevance, context grounding, and precision to determine the degree of improvement in retrieval performance.

In one or more embodiments, after performing the response re-evaluation, the re-evaluation module 412 determines whether the generated response meets predefined satisfaction criteria. If the response is satisfactory, the re-evaluation module 412 finalizes the results for further processing or presentation to the user. However, if the response falls short of the required standards, the re-evaluation module 412 initiates another iteration of improvement, which may involve fine-tuning both the LLM and the SLM.

In one or more embodiments, for LLM, the re-evaluation module 412 proposes sentence window retrieval and auto merging retrieval, to get the better completion along with hyper-parameter tuning. Sentence window retrieval involves dynamically selecting and retrieving smaller, contextually relevant text segments from the chunked content based on the received query.

In one or more embodiments, auto-merging retrieval further refines the process by intelligently combining overlapping or related segments into cohesive units, where the context remains intact while eliminating redundancy. In addition to these strategies, the system 400 applies hyper-parameter tuning to optimize key parameters of the LLM, such as learning rates, batch sizes, attention mechanisms, and context window configurations.

In one or more embodiments, for SLM, the re-evaluation module 412 proposes poly-encoder-re-ranker. The poly-encoder re-ranker is a sophisticated neural ranking mechanism designed to improve the selection and prioritization of document content based on contextual relevance. The approach enables the SLM to efficiently evaluate and rank potential matches by leveraging multi-dimensional embeddings, which capture complex relationships between the input query and the extracted content.

In one or more embodiments, the poly-encoder re-ranker operates by comparing the query embeddings with precomputed document embeddings, utilizing an attention mechanism to identify the most contextually relevant portions of the content.

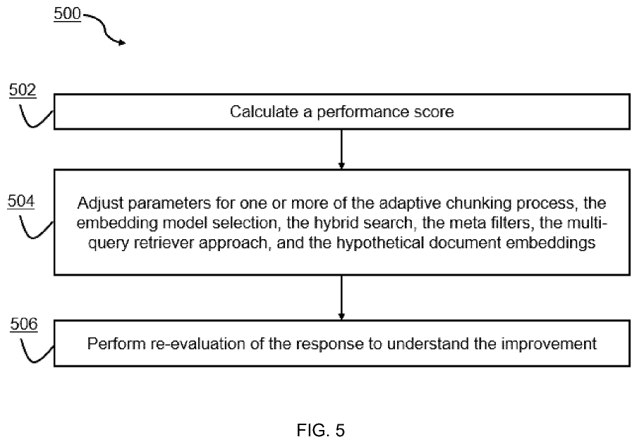

FIG. 5 is a diagram that illustrates a flow chart 500 for a method for evaluating and optimizing a RAG framework, in accordance with an embodiment of the disclosure.

At 502, a performance score is calculated by the performance module 408 based on at least one of a context relevance between the received query and retrieved document portions, a groundedness between a generated response and the retrieved document portions, and an answer relevance between the received query and the generated response.

At 504, parameters are adjusted, by the adjustment module 410, for one or more of the one or more of the adaptive chunking process, the embedding model selection, the hybrid search, the meta filters, the multi-query retriever approach, and the hypothetical document embeddings upon determining that the performance score is below a threshold value.

In one or more embodiments, the adjustment module 410 may modify the chunking strategy, such as altering the chunk size or overlap, for more accurate context retrieval and better alignment with the query. Adjustments may involve refining the chunking approach, such as shifting from fixed-length chunking to more dynamic or semantic chunking, based on the specific characteristics of the content and the user's requirements.

In one or more embodiments, if the performance score indicates a mismatch between the retrieved content and the generated response, the adjustment module 410 may select a different embedding model with a more suitable architecture for the task, which makes representation of the content better in vector space, improving the retrieval process and the overall relevance of the generated responses.

In one or more embodiments, the adjustment module 410 may adjust the hybrid search mechanism by tweaking the balance between vector similarity scores and keyword-based search scores, which involves fine-tuning the weight of the results from semantic search versus traditional keyword matching, depending on the nature of the query and the content being retrieved.

In one or more embodiments, the adjustment module 410 may modify the meta filters applied to the retrieved content, such as adjusting the document metadata and content-type filters. The adjustments make sure that only the most relevant portions of the document content are selected, improving the quality of the response and the accuracy of the retrieval process.

In one or more embodiments, if the retrieval process is not yielding satisfactory results, the adjustment module 410 refines the multi-query retriever approach by generating new, semantically similar query variations. The variations may capture additional aspects of the query that were previously overlooked, for more comprehensive and relevant document retrieval.

In one or more embodiments, the adjustment module 410 may further adjust the use of hypothetical document embeddings by refining the synthetic document representations, which allows the RAG Framework to improve matching between the query and the retrieved content by generating more accurate or diverse hypothetical representations that better capture the query's context.

At 506, re-evaluation of the response is performed to understand the improvement by the re-evaluation module 412. The re-evaluation may utilize metrics such as accuracy, relevance, context grounding, and precision to determine the degree of improvement in retrieval performance.

In one or more embodiments, after performing the response re-evaluation, the re-evaluation module 412 determines whether the generated response meets predefined satisfaction criteria. If the response is satisfactory, the re-evaluation module 412 finalizes the results for further processing or presentation to the user. However, if the response falls short of the required standards, the re-evaluation module 412 initiates another iteration of improvement, which may involve fine-tuning both the LLM and the SLM.

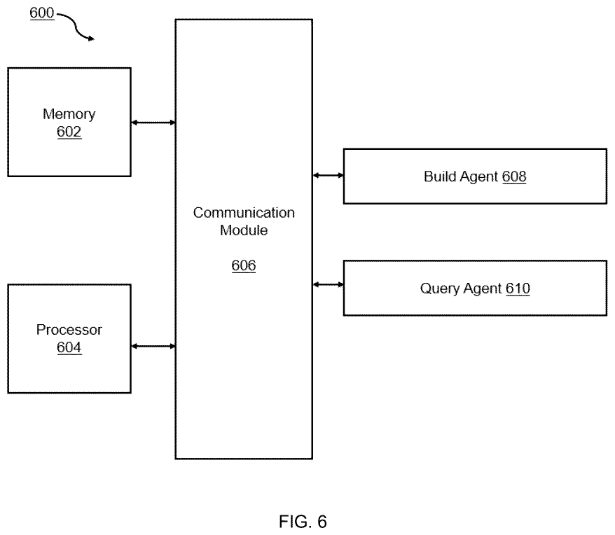

FIG. 6 is a diagram that illustrates the system 600 for agent-based orchestration of a RAG framework, in accordance with an embodiment of the disclosure. Referring to FIG. 6, the system 600 includes a memory 602, a processor 604, a communication module 606, a build agent 608, and a query agent 610.

The memory 602 may comprise suitable logic, and/or interfaces, that may be configured to store instructions (for example, computer-readable program code) that can implement various aspects of the present disclosure.

The processor 604 may comprise suitable logic, interfaces, and/or code that may be configured to execute the instructions stored in the memory 602 to implement various functionalities of the system 600 in accordance with various aspects of the present disclosure. The processor 604 may be further configured to communicate with the various modules of the system 600 through the communication module 606, which manages internal and external data communications.

The build agent 608 may comprise suitable logic, code, and/or interfaces that for managing RAG framework configuration.

In one or more embodiments, the build agent 608 processes the plurality of input documents 102 to identify document types using, and extracts document content.

The build agent 608 is configured to select an adaptive chunking process for the extracted document content. The process adapts to different content types (e.g., textual, tabular, or image-based) and adjusts the chunk sizes accordingly to optimize processing efficiency and accuracy in subsequent stages of the system. The adaptive chunking process employs algorithms that analyze the content and determines appropriate boundaries for creating chunks.

In one or more embodiments, the adaptive chunking process is selected based on chunking variables comprising, a user case type, a speed requirement, a cost requirement, a latency requirement, and a LLM context window size. The chunking variables collectively influence the granularity and method by which content is chunked to align the chunking process with the specific needs of the user.

In one or more embodiments, one or more recommended chunking strategies are determined from fixed-length chunking, sliding window chunking, semantic chunking, and agent-based chunking based on the chunking variables. Thereafter, at least one of the determined chunking strategies are implemented to generate the chunked content.

In one or more embodiments, the determined chunking strategy is implemented by initially monitoring chunk effectiveness metrics, which include context relevance and chunk utilization, for the chunked content. Context relevance refers to how well the content within each chunk maintains its semantic integrity. Chunk utilization measures how efficiently the chunks are being used to enable appropriate distribution of the content across the chunks without significant waste of space or important information.

In one or more embodiments, the chunk size and overlap size are dynamically adjusted based on the monitored chunk effectiveness metrics. For example, if the context relevance falls below an acceptable level, the chunk size may be adjusted to include more content for a richer context. Similarly, if chunk utilization is low, the module may modify the overlap size for more efficient usage of the chunked content.

The build agent 608 is configured to tokenize the chunked content using a tokenization strategy to generate tokenized content. The build agent 608 selects the tokenization strategy based on tokenization variables comprising the use case type, an accuracy requirement, a speed requirement, and a vocabulary type.

The build agent 608 is configured to select an embedding model for the tokenized content based on user requirements.

In one or more embodiments, an embedding model is selected by receiving the user requirements such as domain type, cost requirements, performance requirements, accuracy requirements, and model size constraints.

In one or more embodiments, upon receiving the user requirements, the build agent 608 compares the received user requirements against embedding model parameters such as, model architecture, resource usage, domain applicability, training data type, and model size, and then selects the embedding model having parameters that satisfy the received user requirements.

In one or more embodiments, the build agent 608 analyzes the model architecture, which defines the structure and design of the embedding model, including its layers, activation functions, and mechanisms for handling input data. The build agent 608 also considers resource usage, including the computational power and memory required by the embedding model. As the build agent 608 verifies if the embedding model has been trained on data or adapted for the specific domain indicated in the user requirements. The build agent 608 reviews the training data type, determining whether the selection model's training data encompasses the formats, vocabularies, and contexts relevant to the user's needs. Finally, the build agent 608 examines the model size, which impacts storage and deployment feasibility. Smaller models may be preferred for edge devices or cost-sensitive applications, while larger models may be necessary for more complex or high-accuracy tasks.

The build agent 608 is also configured to generate quantized vector representations by applying a quantization policy to the tokenized content.

In one or more embodiments, applying a quantization policy reduces the numerical precision of the vectors while preserving their essential semantic information. Accordingly, the build agent 608 may convert the high-dimensional tokenized data into a more compact and efficient representation, which can be processed and stored with reduced computational and memory overhead.

In one or more embodiments, the build agent 608 selects the quantization policy based on an accuracy requirement, budget requirements, and a search latency requirement.

In one or more embodiments, applying the quantization policy by the build agent 608 involves determining a target compression level for the vector representations based on the budget requirement, and generating compressed vector representations at the determined target compression level.

In one or more embodiments, the build agent 608 upon generating compressed vector representations, compares retrieval accuracy and search latency of the compressed vector representations against uncompressed vector representations. Thereafter, the target compression level is modified when either the retrieval accuracy or search latency fails to meet predetermined thresholds.

The build agent 608 is also configured to establish a multi-step retrieval strategy for retrieving relevant portions of the document content, which involves hybrid search, meta filters, multi-query retriever approach, and hypothetical document embeddings. The build agent 608 considers both context relevance and groundedness for the retrieval strategy.

The query agent 610 is configured to receive a user query and execute the user query by processing the user query using the configured RAG system.

The query agent 610 converts the received query into a query vector using the selected embedding model and executes the multi-step retrieval strategy.

In one or more embodiments, the query agent 610 executes the multi-step retrieval strategy by performing a semantic search using vector similarity between the query vector and the optimized vector representations, and thereby performing a keyword-based search of the document content.

In one or more embodiments, the query agent 610 implements the hybrid search by combining vector similarity scores from the semantic search with keyword match scores, and filtering the combined results using document metadata and content-type filters, and expanding the query using automatically generated variations.

In one or more embodiments, the query agent 610 applies meta filters to the combined results based on document metadata and executes the multi-query retriever approach by semantically similar query variations.

In one or more embodiments, the query agent 610 utilizes the hypothetical document embeddings by generating synthetic document representations for improved matching, and generates a comprehensive set of relevant document portions from the executed retrieval strategy.

In one or more embodiments, the query agent 610 finally ranks the comprehensive set based on the context relevance and groundedness.

The build agent 608 is also configured to calculate a performance score based on at least one of a context relevance between the received query and retrieved document portions, a groundedness between a generated response and the retrieved document portions, and an answer relevance between the received query and the generated response.

The build agent 608 adjusts parameters for one or more of the one or more of the adaptive chunking process, the embedding model selection, the hybrid search, the meta filters, the multi-query retriever approach, and the hypothetical document embeddings upon determining that the performance score is below a threshold value.

In one or more embodiments, the build agent 608 may modify the chunking strategy, such as altering the chunk size or overlap, for more accurate context retrieval and better alignment with the query. Adjustments may involve refining the chunking approach, such as shifting from fixed-length chunking to more dynamic or semantic chunking, based on the specific characteristics of the content and the user's requirements.

In one or more embodiments, if the performance score indicates a mismatch between the retrieved content and the generated response, the build agent 608 may select a different embedding model with a more suitable architecture for the task, which makes representation of the content better in vector space, improving the retrieval process and the overall relevance of the generated responses.

In one or more embodiments, the build agent 608 may adjust the hybrid search mechanism by tweaking the balance between vector similarity scores and keyword-based search scores, which involves fine-tuning the weight of the results from semantic search versus traditional keyword matching, depending on the nature of the query and the content being retrieved.

In one or more embodiments, the build agent 608 may modify the meta filters applied to the retrieved content, such as adjusting the document metadata and content-type filters. The adjustments make sure that only the most relevant portions of the document content are selected, improving the quality of the response and the accuracy of the retrieval process.

In one or more embodiments, if the retrieval process is not yielding satisfactory results, the build agent 608 refines the multi-query retriever approach by generating new, semantically similar query variations. The variations may capture additional aspects of the query that were previously overlooked, for more comprehensive and relevant document retrieval.

In one or more embodiments, the build agent 608 may further adjust the use of hypothetical document embeddings by refining the synthetic document representations, which allows the RAG system to improve matching between the query and the retrieved content by generating more accurate or diverse hypothetical representations that better capture the query's context.

The query agent 610 then implements the adjusted parameters to optimize query processing and improve the accuracy and relevance of the RAG system's responses. The adjusted parameters may include modifications to the chunking strategy, embedding model selection, hybrid search mechanism, meta filters, multi-query retriever approach, and hypothetical document embeddings. By applying these adjustments, the query agent 610 makes the retrieved document portions to align more closely with the context and intent of the received query.

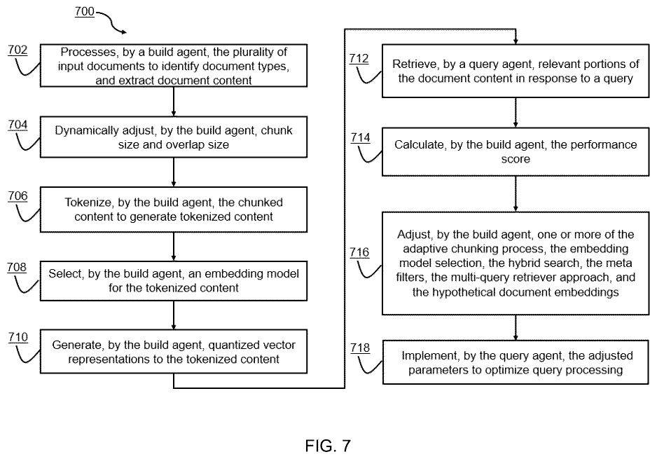

FIG. 7 is a diagram that illustrates a flow chart 700 for a method for agent-based orchestration of a RAG framework, in accordance with an embodiment of the disclosure.

At 702, the build agent 608 processes the plurality of input documents 102 to identify document types, and extract document content.

At 704, the build agent 608 dynamically adjusts the chunk size and overlap size based on the monitored chunk effectiveness metrics. For example, if the context relevance falls below an acceptable level, the chunk size may be adjusted to include more content for a richer context. Similarly, if chunk utilization is low, the module may modify the overlap size for more efficient usage of the chunked content.

In one or more embodiments, if after these adjustments, the monitored chunk effectiveness metrics fall below predefined thresholds indicating that the chunking process is still not performing optimally, the build agent 608 further optimizes the adjusted chunk size and overlap size using a genetic algorithm, which operates by evaluating multiple potential chunk configurations, each representing a genetic solution to the chunking process. The genetic algorithm iteratively evolves the chunking strategy by selecting the best-performing configurations and combining them to generate improved solutions.

At 706, the build agent 608 tokenizes the chunked content using a tokenization strategy to generate tokenized content. The build agent 608 selects the tokenization strategy based on tokenization variables comprising the use case type, an accuracy requirement, a speed requirement, and a vocabulary type.

At 708, the build agent 608 selects an embedding model for the tokenized content based on user requirements.

In one or more embodiments, the build agent 608 selects the embedding model by receiving the user requirements such as domain type, cost requirements, performance requirements, accuracy requirements, and model size constraints.

In one or more embodiments, upon receiving the user requirements, the build agent 608 compares the received user requirements against embedding model parameters such as, model architecture, resource usage, domain applicability, training data type, and model size, and then selects the embedding model having parameters that satisfy the received user requirements.

In one or more embodiments, the build agent 608 analyzes the model architecture, which defines the structure and design of the embedding model, including its layers, activation functions, and mechanisms for handling input data. The build agent 608 also considers resource usage, including the computational power and memory required by the embedding model. As the build agent 608 verifies if the embedding model has been trained on data or adapted for the specific domain indicated in the user requirements. The build agent 608 reviews the training data type, determining whether the selection model's training data encompasses the formats, vocabularies, and contexts relevant to the user's needs. Finally, the build agent 608 examines the model size, which impacts storage and deployment feasibility. Smaller models may be preferred for edge devices or cost-sensitive applications, while larger models may be necessary for more complex or high-accuracy tasks.

At 710, the build agent 608 generates quantized vector representations by applying a quantization policy to the tokenized content.

In one or more embodiments, applying a quantization policy reduces the numerical precision of the vectors while preserving their essential semantic information. Accordingly, the build agent 608 may convert the high-dimensional tokenized data into a more compact and efficient representation, which can be processed and stored with reduced computational and memory overhead.

In one or more embodiments, the build agent 608 selects the quantization policy based on an accuracy requirement, budget requirements, and a search latency requirement.

In one or more embodiments, applying the quantization policy by the involves determining a target compression level for the vector representations based on the budget requirement, and generating compressed vector representations at the determined target compression level.

At 712, the query agent 610 retrieves relevant portions of the document content, in response to a received query. The query agent 610 utilizes a multi-step retrieval strategy for retrieving relevant portions of the document content, which involves hybrid search, meta filters, multi-query retriever approach, and hypothetical document embeddings. The query agent 610 considers both context relevance and groundedness for the retrieval strategy.

In one or more embodiments, the query agent 610 converts the received query into a query vector using the selected embedding model and executes the multi-step retrieval strategy.

In one or more embodiments, the query agent 610 executes the multi-step retrieval strategy by performing a semantic search using vector similarity between the query vector and the optimized vector representations, and thereby performing a keyword-based search of the document content.

In one or more embodiments, the query agent 610 implements the hybrid search by combining vector similarity scores from the semantic search with keyword match scores, and filtering the combined results using document metadata and content-type filters, and expanding the query using automatically generated variations.

In one or more embodiments, the query agent 610 applies meta filters to the combined results based on document metadata and executes the multi-query retriever approach by semantically similar query variations.

In one or more embodiments, the query agent 610 utilizes the hypothetical document embeddings by generating synthetic document representations for improved matching, and generates a comprehensive set of relevant document portions from the executed retrieval strategy.

In one or more embodiments, the query agent 610 finally ranks the comprehensive set based on the context relevance and groundedness.

At 714, the build agent 608 calculates a performance score based on at least one of a context relevance between the received query and retrieved document portions, a groundedness between a generated response and the retrieved document portions, and an answer relevance between the received query and the generated response.

At 716, the build agent 608 adjusts parameters for one or more of the one or more of the adaptive chunking process, the embedding model selection, the hybrid search, the meta filters, the multi-query retriever approach, and the hypothetical document embeddings upon determining that the performance score is below a threshold value.

In one or more embodiments, the build agent 608 may modify the chunking strategy, such as altering the chunk size or overlap, for more accurate context retrieval and better alignment with the query. Adjustments may involve refining the chunking approach, such as shifting from fixed-length chunking to more dynamic or semantic chunking, based on the specific characteristics of the content and the user's requirements.

In one or more embodiments, if the performance score indicates a mismatch between the retrieved content and the generated response, the build agent 608 may select a different embedding model with a more suitable architecture for the task, which makes representation of the content better in vector space, improving the retrieval process and the overall relevance of the generated responses.

In one or more embodiments, the build agent 608 may adjust the hybrid search mechanism by tweaking the balance between vector similarity scores and keyword-based search scores, which involves fine-tuning the weight of the results from semantic search versus traditional keyword matching, depending on the nature of the query and the content being retrieved.

In one or more embodiments, the build agent 608 may modify the meta filters applied to the retrieved content, such as adjusting the document metadata and content-type filters. The adjustments make sure that only the most relevant portions of the document content are selected, improving the quality of the response and the accuracy of the retrieval process.

In one or more embodiments, if the retrieval process is not yielding satisfactory results, the build agent 608 refines the multi-query retriever approach by generating new, semantically similar query variations. The variations may capture additional aspects of the query that were previously overlooked, for more comprehensive and relevant document retrieval.

In one or more embodiments, the build agent 608 may further adjust the use of hypothetical document embeddings by refining the synthetic document representations, which allows the RAG system to improve matching between the query and the retrieved content by generating more accurate or diverse hypothetical representations that better capture the query's context.

At 718, the query agent 610 then implements the adjusted parameters to optimize query processing and improve the accuracy and relevance of the system's responses. The adjusted parameters may include modifications to the chunking strategy, embedding model selection, hybrid search mechanism, meta filters, multi-query retriever approach, and hypothetical document embeddings. By applying these adjustments, the query agent 610 makes the retrieved document portions to align more closely with the context and intent of the received query.

The method and system is advantageous in that it generates an optimal tokenization strategy that dynamically adapts to user-defined parameters, such as accuracy, speed, and vocabulary type, which makes it to meet the specific needs of diverse use cases.

The method and system effectively overcome existing challenges in document retrieval and processing by optimally analyzing both the use case and user-specific requirements to recommend the most suitable embedding model for a given application. The system customizes the embedding model selection based on key factors such as the complexity of the application, domain-specific terminology, and the accuracy or speed requirements set by the user.

Additionally, the method and system significantly enhances the adaptability and performance of the retrieval process by enabling the fine-tuning of the embedding model using domain-specific data, particularly in cases where the results generated by the base model are not satisfactory. The fine-tuning capability addresses a critical limitation of conventional models that may not fully capture the unique nuances and intricacies of specialized domains, such as legal, medical, or technical fields.

Further, the method and system greatly enhances the retrieval process by suggesting the most appropriate quantization strategy, tailored to the specific needs of the application, based on explicit parameters such as response accuracy, budget constraints, and search latency. The strategic approach optimizes the trade-off between maintaining high-quality responses and minimizing computational resources, so that the system can scale effectively across a variety of user needs and constraints.

Furthermore, the method and system automatically selects most optimal techniques from a range of available options to generate high-quality responses. By automating the selection process, the system eliminates the need for manual intervention, streamlining the response generation while optimizing for performance and accuracy. This approach guarantees that the system can adapt to different user needs and application scenarios without compromising on the quality of the output.

Furthermore, the method and system employs a variety of innovative techniques and methods to achieve optimal response quality. One such method is the optimal chunking strategy detection framework, which confirms the content from input documents is efficiently divided into manageable chunks. This framework adapts the chunking process based on critical factors such as the type of use case, speed and latency requirements, as well as the context window size of the LLM, ensuring that content is chunked in a manner that maximizes retrieval effectiveness. Additionally, the system incorporates a rule-based tokenization technique to make sure that content is tokenized in a way that preserves semantic meaning while reducing unnecessary complexity.

Another significant advantage of the method and system is its ability to save both time and effort. With the automated agentic framework of the present system, the selection of the most suitable approach is done automatically, based on scenario-specific parameters such as use case type, accuracy, speed, and other relevant requirements. By automating this decision-making process, the system significantly reduces the manual effort needed to identify and apply the most effective techniques. As a result, this leads to a considerable reduction in the time required for development, testing, and optimization.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A computer-implemented method for improving retrieval accuracy in a Retrieval Augmented Generation (RAG) system, comprising:
receiving, by a processor, a plurality of input documents;
analyzing, by the one or more processors, each of the plurality of input documents using a Small Language Model (SLM), to identify a document type for each of the plurality of input documents, wherein the document type is one of: a markdown document, a programming code document, a tabular document, and an image-containing document;
extracting, by the processor, document content from each input document using document type-specific extraction methods, wherein table content and image content within the document content are converted to text summaries;
implementing, by the processor, an adaptive chunking process for the extracted document content to generate chunked content, wherein the adaptive chunking process is selected based on chunking variables comprising: a use case type, a speed requirement, a cost requirement, a latency requirement, and a Large Language Model (LLM) context window size;
tokenizing, by the processor, the chunked content using a tokenization strategy to generate tokenized content, wherein the tokenization strategy is selected based on tokenization variables comprising: the use case type, an accuracy requirement, a speed requirement, and a vocabulary type;
selecting, by the processor, an embedding model for the tokenized content based on user requirements;
applying, by the processor, a quantization policy to the tokenized content to generate quantized vector representations, wherein the quantization policy is selected based on: an accuracy requirement, a budget requirement, and a search latency requirement;
generating, by the processor, optimized vector representations of the quantized vector representations using the selected embedding model and the applied quantization policy; and
retrieving, by the processor in response to a received query, relevant portions of the document content using a multi-step retrieval strategy comprising hybrid search, meta filters, multi-query retriever approach and hypothetical document embeddings, wherein the retrieval strategy considers both context relevance and groundedness.

2. The method of claim 1, wherein implementing the adaptive chunking process comprises:
determining one or more recommended chunking strategies from: fixed-length chunking, sliding window chunking, semantic chunking, and agent-based chunking based on the chunking variables; and
implementing at least one of the determined chunking strategies to generate the chunked content.

3. The method of claim 2, wherein implementing the at least one determined chunking strategy comprises:
monitoring chunk effectiveness metrics comprising context relevance and chunk utilization for the chunked content;
dynamically adjusting chunk size and overlap size based on the monitored chunk effectiveness metrics; and
optimizing the adjusted chunk size and overlap size using a genetic algorithm when the monitored chunk effectiveness metrics fall below predetermined thresholds.

4. The method of claim 1, wherein selecting the embedding model comprises:
receiving the user requirements comprising: domain type, cost requirements, performance requirements, accuracy requirements, and model size constraints;
comparing the received user requirements against embedding model parameters comprising: model architecture, resource usage, domain applicability, training data type, and model size; and
selecting an embedding model having parameters that satisfy the received user requirements.

5. The method of claim 1, wherein applying the quantization policy comprises:
determining a target compression level for the vector representations based on the budget requirement;
generating compressed vector representations at the determined target compression level;
comparing retrieval accuracy and search latency of the compressed vector representations against uncompressed vector representations; and
modifying the target compression level when either the retrieval accuracy or search latency fails to meet predetermined thresholds.

6. The method of claim 1, wherein retrieving relevant portions of the document content comprises:
converting the received query into a query vector using the selected embedding model;
executing the multi-step retrieval strategy by:
performing a semantic search using vector similarity between the query vector and the optimized vector representations;
performing a keyword-based search of the document content;
implementing the hybrid search by:
combining vector similarity scores from the semantic search with keyword match scores;
filtering the combined results using document metadata and content-type filters;
expanding the query using automatically generated variations;
applying the meta filters to the combined results based on document metadata;
executing the multi-query retriever approach by semantically similar query variations;
utilizing the hypothetical document embeddings by generating synthetic document representations for improved matching;
generating a comprehensive set of relevant document portions from the executed retrieval strategy; and
ranking the comprehensive set based on the context relevance and groundedness.

7. The method of claim 1, further comprising:
calculating a performance score based on at least one of: a context relevance between the received query and retrieved document portions, a groundedness between a generated response and the retrieved document portions, and an answer relevance between the received query and the generated response;
when the calculated performance score is below a threshold adjusting parameters for one or more of: the adaptive chunking process, the embedding model selection, the hybrid search, the meta filters, the multi-query retriever approach, and the hypothetical document embeddings; and
performing a response re-evaluation to understand the improvement, and initiate a subsequent round of improvement for LLM and SLM if the re-evaluation response is determined to be unsatisfactory, wherein sentence window retrieval, auto merging retrieval along with hyper-parameter tuning are proposed for the LLM, and a Poly-encoder-Re-ranker is proposed for the SLM.

8. A system for improving retrieval accuracy in a Retrieval Augmented Generation (RAG) framework, comprising:
a processor;
a memory storing instructions that, when executed by the processor, cause the system to:
receive a plurality of input documents;
identify, using a Small Language Model (SLM), a document type for each of the plurality of input documents, wherein the document type is one of: a markdown document, a programming code document, a tabular document, and an image-containing document;
extract document content from each input document using document type-specific extraction methods, wherein table content and image content within the document content are converted to text summaries;
implement an adaptive chunking process for the extracted document content to generate chunked content, wherein the adaptive chunking process is selected based on chunking variables comprising: a use case type, a speed requirement, a cost requirement, a latency requirement, and a Large Language Model (LLM) context window size;
tokenize the chunked content using a tokenization strategy to generate tokenized content, wherein the tokenization strategy is selected based on tokenization variables comprising: the use case type, an accuracy requirement, a speed requirement, and a vocabulary type;
select an embedding model for the tokenized content based on user requirements;
apply a quantization policy to the tokenized content to generate quantized vector representations, wherein the quantization policy is selected based on: an accuracy requirement, a budget requirement, and a search latency requirement;
generate optimized vector representations of the quantized vector representations using the selected embedding model and the applied quantization policy; and
retrieve, in response to a received query, relevant portions of the document content using a multi-step retrieval strategy comprising hybrid search, meta filters, multi-query retriever approach and hypothetical document embeddings, wherein the retrieval strategy considers both context relevance and groundedness.

9. The system of claim 8, wherein implementing the adaptive chunking process comprises:
determining one or more recommended chunking strategies from: fixed-length chunking, sliding window chunking, semantic chunking, and agent-based chunking based on the chunking variables; and
implementing at least one of the determined chunking strategies to generate the chunked content.

10. The system of claim 9, wherein implementing the at least one determined chunking strategy comprises:
monitoring chunk effectiveness metrics comprising context relevance and chunk utilization for the chunked content;
dynamically adjusting chunk size and overlap size based on the monitored chunk effectiveness metrics; and
optimizing the adjusted chunk size and overlap size using a genetic algorithm when the monitored chunk effectiveness metrics fall below predetermined thresholds.

11. The system of claim 8, wherein selecting the embedding model comprises:
receiving the user requirements comprising domain type, cost requirements, performance requirements, accuracy requirements, and model size constraints;
comparing the received user requirements against embedding model parameters comprising model architecture, resource usage, domain applicability, training data type, and model size; and
selecting an embedding model having parameters that satisfy the received user requirements.

12. The system of claim 8, wherein applying the quantization policy comprises:
determining a target compression level for the vector representations based on the budget requirement;
generating compressed vector representations at the determined target compression level;
comparing retrieval accuracy and search latency of the compressed vector representations against uncompressed vector representations; and
modifying the target compression level when either the retrieval accuracy or search latency fails to meet predetermined thresholds.

13. The system of claim 8, wherein retrieving relevant portions of the document content comprises:
converting the received query into a query vector using the selected embedding model;
executing the multi-step retrieval strategy by:
performing a semantic search using vector similarity between the query vector and the optimized vector representations;
performing a keyword-based search of the document content;
implementing the hybrid search by:
combining vector similarity scores from the semantic search with keyword match scores;
filtering the combined results using document metadata and content-type filters;
expanding the query using automatically generated variations;
applying the meta filters to the combined results based on document metadata;
executing the multi-query retriever approach by semantically similar query variations;
utilizing the hypothetical document embeddings by generating synthetic document representations for improved matching;
generating a comprehensive set of relevant document portions from the executed retrieval strategy; and
ranking the comprehensive set based on the context relevance and groundedness.

14. The system (104) of claim 8, wherein the memory (202) stores further instructions that, when executed by the processor (204), cause the system (104) to:
calculate a performance score based on at least one of: a context relevance between the received query and retrieved document portions, a groundedness between a generated response and the retrieved document portions, and an answer relevance between the received query and the generated response;
when the calculated performance score is below a threshold adjust parameters for one or more of: the adaptive chunking process, the embedding model selection, the hybrid search, the meta filters, the multi-query retriever approach, and the hypothetical document embeddings; and
perform a response re-evaluation to understand the improvement, and initiate a subsequent round of improvement for LLM and SLM if the re-evaluation response is determined to be unsatisfactory, wherein sentence window retrieval, auto merging retrieval along with hyper-parameter tuning are proposed for the LLM, and a Poly-encoder-Re-ranker is proposed for the SLM.

15. A computer-implemented method for evaluating and optimizing a Retrieval Augmented Generation (RAG) system, comprising:
receiving, by a processor, a query, retrieved document portions, and a generated response from the RAG system;
calculating, by the processor, performance scores comprising: a context relevance score between the query and the retrieved document portions, a groundedness score between the generated response and the retrieved document portions, and an answer relevance score between the query and the generated response;
when at least one of the calculated performance scores falls below a threshold initiating a first optimization phase by adjusting parameters of an adaptive chunking process, an embedding model selection, a multi-step retrieval strategy comprising hybrid search, meta filters, multi-query retriever approach and hypothetical document embeddings; and
perform a response re-evaluation to understand the improvement, and initiate a subsequent round of improvement for LLM and SLM if the re-evaluation response is determined to be unsatisfactory, wherein sentence window retrieval, auto merging retrieval along with hyper-parameter tuning are proposed for the LLM, and a Poly-encoder-Re-ranker is proposed for the SLM.

16. A system for evaluating and optimizing a Retrieval Augmented Generation (RAG) system, comprising:
a processor;
a memory storing instructions that, when executed by the processors, cause the system to:
receive a query, retrieved document portions, and a generated response from the RAG system;
calculate performance scores comprising: a context relevance score between the query and the retrieved document portions, a groundedness score between the generated response and the retrieved document portions, and an answer relevance score between the query and the generated response;
when at least one of the calculated performance scores falls below a threshold: initiate a first optimization phase by adjusting parameters of:
an adaptive chunking process, an embedding model selection, a multi-step retrieval strategy comprising hybrid search, meta filters, multi-query retriever approach and hypothetical document embeddings; and
perform a response re-evaluation to understand the improvement, and initiate a subsequent round of improvement for LLM and SLM if the re-evaluation response is determined to be unsatisfactory, wherein sentence window retrieval, auto merging retrieval along with hyper-parameter tuning are proposed for the LLM, and a Poly-encoder-Re-ranker is proposed for the SLM.

17. A computer-implemented method for agent-based orchestration of a Retrieval Augmented Generation (RAG) system, comprising:
initializing, by a processor a build agent for managing RAG system configuration, and a query agent for managing query processing;
configuring, by the build agent, the RAG system by:
processing a plurality of input documents to identify document types and extract document content;
selecting an adaptive chunking process based on chunking variables;
determining an embedding model based on user requirements;
configuring a quantization policy based on an accuracy requirement, a budget requirement, and a search latency requirement; and
establishing a multi-step retrieval strategy comprising hybrid search, meta filters, multi-query retriever approach and hypothetical document embeddings;
receiving, by the query agent, a user query;
executing, by the query agent, the user query by:
processing the received query using the configured RAG system;
retrieving document portions using the established multi-step retrieval strategy;
generating a response based on the retrieved document portions;
monitoring, by the build agent, RAG system performance by:
calculating performance scores comprising context relevance, groundedness, and answer relevance;
initiating parameter adjustments when the performance scores fall below predetermined thresholds; and
coordinating with the query agent to implement the adjusted parameters.

18. A system for agent-based orchestration of a Retrieval Augmented Generation (RAG) system, comprising:
a processor;
a memory storing instructions that, when executed by the processor, cause the system to:
initialize a build agent for managing RAG system configuration, and a query agent for managing query processing;
configure, by the build agent, the RAG system by:
processing a plurality of input documents to identify document types and extract document content;
selecting an adaptive chunking process based on chunking variables;
determining an embedding model based on user requirements;
configuring a quantization policy based on an accuracy requirement, a budget requirement, and a search latency requirement; and
establishing a multi-step retrieval strategy comprising hybrid search, meta filters, multi-query retriever approach and hypothetical document embeddings;
receive, by the query agent (610), a user query;
execute, by the query agent (610):
processing the received query using the configured RAG system;
retrieving document portions using the established multi-step retrieval strategy;
generating a response based on the retrieved document portions;
monitor, by the build agent (608), RAG system performance by:
calculating performance scores comprising context relevance, groundedness, and answer relevance;
initiating parameter adjustments when the performance scores fall below predetermined thresholds; and
coordinating with the query agent (610) to implement the adjusted parameters.
